(19) United States
(12) Patent Application Publication
(10) Pub. No.: US 2015/0370766 A1
(43) Pub. Date: Dec. 24, 2015

(54) ONTOLOGY-DRIVEN REQUIREMENTS ENGINEERING METHODOLOGY MIND-MAPPER

(71) Applicant: Airbus Operations Limited, Bristol (GB)

(72) Inventors: Mario KOSSMANN, BRISTOL (GB); Mahammed ODEH, BRISTOL (GB); Rami ZAYED, BRISTOL (GB)

(21) Appl. No.: 14/308,376

(22) Filed: Jun. 18, 2014

(51) Int. Cl. G06F 17/24; G06F 17/21

(52) U.S. Cl. CPC G06F 17/24; G06F 17/211

(57) ABSTRACT

A computer implemented method comprising the steps of, at a computer processor: receiving an ontology based specification file; receiving an input from a user indicative of one or more aspects of the requirements engineering based specification file to visualise; automatically generating, at a processor, a mindmap derived from the selected aspects of the requirements engineering based specification file; and displaying said derived mindmap at a display.

### FIELD OF THE INVENTION

The present invention relates to improvements in computer implemented tools relating to Systems Engineering, Requirements Engineering and Knowledge Management. In particular the invention provides computer implemented methods and systems that facilitate the development and maintenance of domain knowledge and to visualise machine readable ontologies in the form of human-friendly mind maps, and enable updates of these ontologies in the mind map format prior to re-importing the information into die ontologies

### BACKGROUND OF THE INVENTION

Requirements engineering and management aims to aid the development of products or services in an industry and sometimes to the subsequent management of the products or services through their entire life-cycle. Computer implemented tools are known for use in requirements engineering which are intended to improve the requirements engineering process and hopefully to thereby improve the ultimate product or service or at least improve the efficiency of their development.

Ontology-driven Requirements Engineering Methodology (OntoREM described in U.S. Ser. No. 14/364,603) had been used to develop explicit domain knowledge including requirements that could be used and re-used for the development or modification of, say, aircraft or sub-systems thereof, as well as the related industrialization system or sub-systems thereof. By structuring the problem space and solution space for a first domain, the domain knowledge and ontology may be automatically imported into rather domains (where appropriate), as well as reduce the time and costs of producing, analyzing and validating them.

It is also known to use mind maps during requirements engineering. Such mind maps may be used to enhance activities through dialogue with relevant stakeholders and domain experts. In particular the mindmaps aide the users to visualise and categorize the requirements engineering process as well as promote natural linking and more ideas during the process.

Mindmapping is used in requirement engineering however the creation of such maps is manual, prone to error and time consuming.

### SUMMARY OF THE INVENTION

A first aspect of the invention provides a computer implemented method comprising the steps of, at a computer processor; receiving an ontology based specification file; receiving an input from a user indicative of one or more aspects of the specification file to visualise; automatically generating, at a processor, a mindmap derived from the selected aspects of the specification file; and displaying said derived mindmap at a display.

A further aspect of the invention a computer implemented method comprising the steps of, at a computer processor; displaying a mindmap based on one or more selected aspects of an ontology specification file written in the Web Ontology Language; editing one or more features of the displayed mindmap; automatically updating the ontology specification file so as to reflect the changes made to the mindmap in the ontology specification file.

### BRIEF DESCRIPTION OF THE DRAWINGS

Embodiments of the invention will now be described with reference to the accompanying drawings, in winch:

FIG. 1 is a schematic of the apparatus of the invention;

FIG. 2A flow chart of the process of automatically generating a mindmap and FIG. 2B is a flow chart of the process of updating an ontology based on changes made to a mindmap;

FIG. 3 is an example of a solution space domain ontology mindmap;

FIG. 4A is an example of a class hierarchy mindmap, FIG. 4B is an example of a mindmap for object properties and FIG. 4C an example of a mindmap for datatype properties;

FIG. 5A is an example of a traceability mindmap generated and FIG. 5B is an example of the traceability mindmap for the associated goals, root goals and requirements for a particular need as identified in FIG. 5A; and

FIG. 6 is shown a schematic representation of the architecture of the ontology driven requirements engineering mind mapping (OMM) software

### DETAILED DESCRIPTION OF EMBODIMENT(S)

Although the invention has been described with reference to one or more preferred embodiments, it will be appreciated that various changes or modifications may be made without departing from the scope of the invention as defined in the appended claim.

The invention provides a system and method for automatically deriving ontology mindmaps from requirements engineering software. The invention allows for bi-directional, automated, customizable domain knowledge (data) transfers between a mindmapping environment, in a format that allows for the mindmap to be graphically rendered, and the machine readable ontology environment, provided the ontologies in question are specified in the OWL DL (Description Logic) notation.

Such automation allows for the errors in creation of the mindmaps to be avoided, thus ensuring data integrity, and furthermore allows for bi-directional editing. That is to say any edits which are made to the mindmap are automatically reflected in the machine readable ontology environment. Similarly, where the domain is updated in the machine readable ontology environment, for example using the OWL DL notation, the mindmap is automatically updated. Thus the invention enables a systems engineer (or manager), to update the ontology environment as well as the end user (or requirements engineer) to update the mindmap visualization environment.

The invention is described with reference to the OntoREM method and system, as described in U.S. Ser. No. 13/364,603 the contents of which are hereby incorporated by reference.

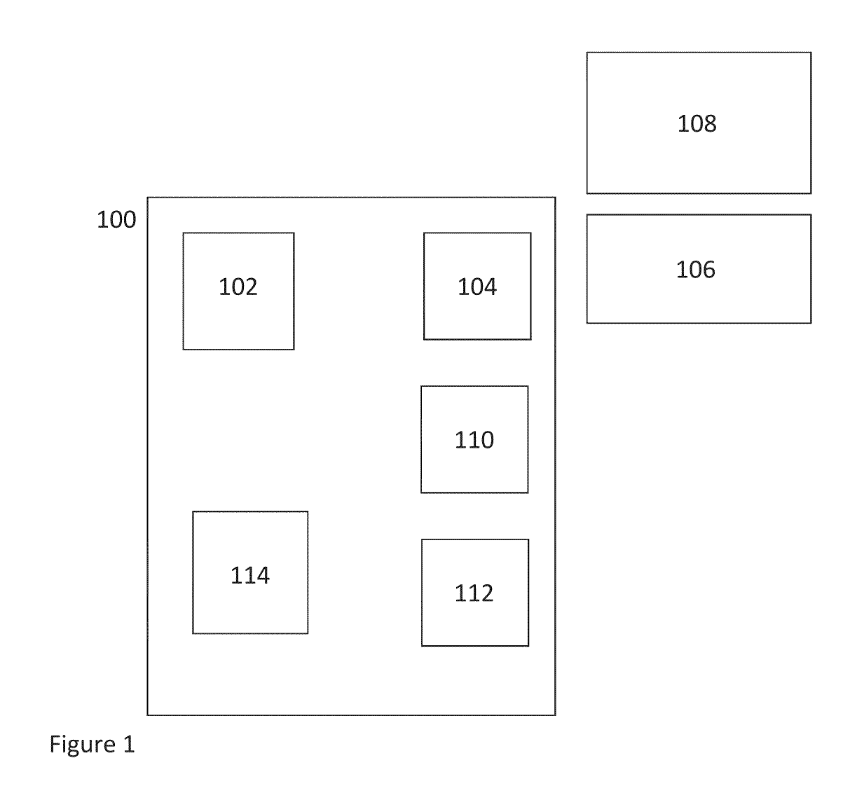

FIG. 1 is a schematic of the apparatus in an embodiment of the invention.

There is shown computing device 100, comprising a processor 102, a memory 104, user input device 106, output device 108, a requirements engineering module 110, visualization module 112, network connection 114. Modules 110 and 112 may be part of the memory 104 or may be provided via separate hardware components such as a circuit or an external memory or storage device that includes executable code which may be executed by the processor 102.

The invention is executed on a computing device 100 such as desktop computer, laptop, tablet etc. The computing device may be connected to a network, such an intranet or the internet, via the network connection 114 or function as a stand-alone device.

In an embodiment the computing device 100 has installed thereon the requirements engineering module 110, and visualization module 112. The requirements engineering module 110 has thereon a known requirements engineering software program to enable a user to create and populate a problem and solution domain for the purpose of project management. In a preferred embodiment the requirements engineering module 110 is the OntoREM requirements engineering program.

The user is therefore able to interact with the requirements engineering module 110 via the user input device 106 (such as a keyboard, mouse, touchscreen display) and the output device 108 (such as a monitor). Furthermore the device 100 is configured to enable the user to visualise various aspects of the ontology generated by the requirements engineering module 110, via the visualization module 112. The functionality and format of the visualization module 112 are described in detail below. The visualization module 112 automatically generates a mindmap based on the ontology generated by the requirements engineering module 110. The mindmap is displayed on the output device 108, and furthermore the user is able to interact with the displayed mindmap via the user input device 106. As described in detail below the interaction of the user with the mindmap may also result in the ontology being updated. Therefore there is a bi-directional flow of information between the requirements engineering module 110 and visualization module 112.

The execution of the requirements engineering module 110 and visualization module 112 as well as the user input 106 and output 108 are controlled by the processor 102.

In further embodiments one or both of the requirements engineering module 110, and visualization module 112 are stored externally to the computing device 100 and the computing device 100 is able to access the modules using the network connection 114. In such embodiments the requirements engineering module 110 and visualization module 112 are available to the computing device in the known software as a service manner (or on demand software).

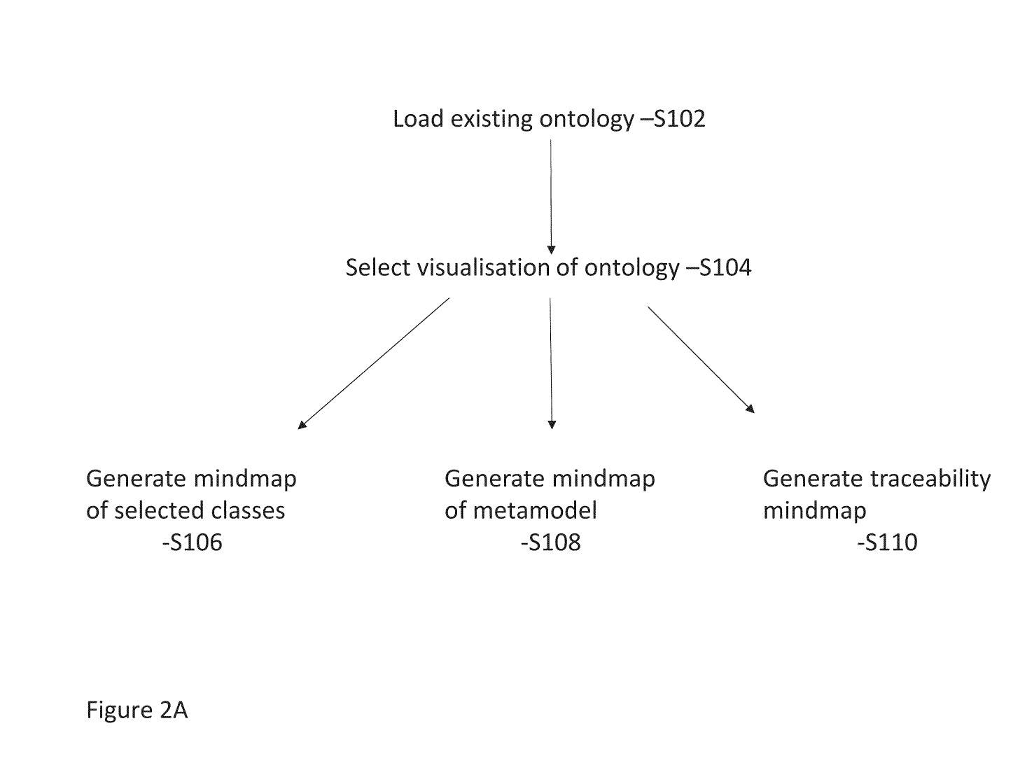

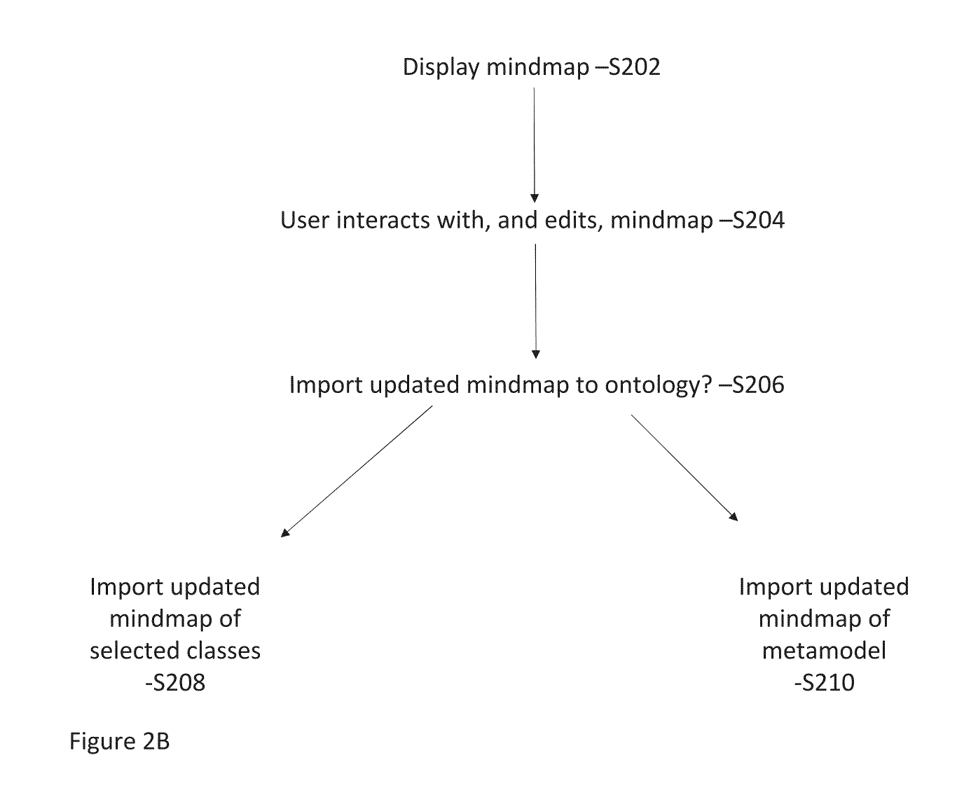

In FIGS. 2A and 28 there is shown a flow chart of the process of the bi-directional mindmap creation. The following description is made with reference to a known computer (networked or otherwise), such as described with reference to FIG. 1, which is running an ontology based requirements engineering program such as OntoREM. In particular the use of the metamodel which specifies as part of the requirements engineering process the roles, tools, methods, goal and requirement templates, deployment and documentation along with all the relationship information.

At step S102 an existing ontology is loaded into the program. The existing ontology is a completed, or partially completed, requirements engineering project in which the problem and solution spaces have previously been defined. Preferably, using the techniques described in U.S. Ser. No. 13/364,603 the problem and solution domains and metamodels have been populated using previously identified optimal solutions. The uploaded ontology in the preferred embodiment adheres to the OWL specifications as defined by the World Wide Web Consortium (W3C).

At step S104 the user decides how to visualise the uploaded ontology. The user, in the preferred embodiment, is presented with three options: generate a visual mindmap based on a selection of classes from the uploaded ontology (see step S106); generate a mindmap for the metamodel of the uploaded ontology (see step S108); or generate visual traceability mindmaps for the needs, goals and requirements as defined in the uploaded ontology.

At step S104 the user is presented with the options, via a user interface, and enters their selection through known means. In an embodiment the selection is presented to the user in the form, of a drop-down menu. In an embodiment the selection is made through command line prompts, or any other accepted mechanism.

If the user selects the option to generate a visual mindmap based on a selection of classes front the uploaded ontology the process proceeds to step S106.

At step S106 the process continues to generate a mindmap for the chosen classes of the uploaded ontology. Each generated mindmap will graphically represent the selected class, its subclasses, the class hierarchies, the instances of each class, the properties of each instance, and the values assigned to each property.

Advantageously, such mindmaps work as data templates called Ontology Mindmap Templates; and they can be reused later to import data back into the associated ontology files to enhance the bi-directional transfer of data.

At step S106 the user is presented with a list of all the classes present in the uploaded ontology and the user selects one or more of the classes. In a preferred embodiment the problem ontology consists of the classes relating to each relevant person or actor in the problem space, aspects, general or global concerns regarding a problem, the global objectives and local objectives, life cycle phases, needs, and workflows. Similar classes exist for the solution domain and metamodel.

When a mindmap of selected classes is generated from an uploaded ontology (preferably based on the OntoREM metamodel), and the user has selected the option to automatically generate a mindmap on the selected classes the process of the generation of the mindmap begins. Advantageously as the ontology is specified in the OWL notation, the mindmaps can be automatically generated.

In the OWL notation it is possible to identify all existing instances associated with each of the selected classes, as such association is specified within the OWL notation. Furthermore it is possible to identify all the available information that is stored by means of object type or datatype properties and associated values for the instance. Such ordering also defines the hierarchy within the mindmap. In an embodiment the first level is defined by the classes, the second level the instances, the third level the object and datatype properties and the final level the property values.

Once the number of instances have been determined an initial visual spacing/separation is determined, and plotted onto the mindmap as branches. Preferably the instances have an equal visual separation. For each instance the information identified for the instance (as determined by the OWL notation) is then plotted onto the mindmap as sub-branches.

The visualization of the mindmap is preferably performed using commercially available mindmapping software tools such as MindManager from MindJet.

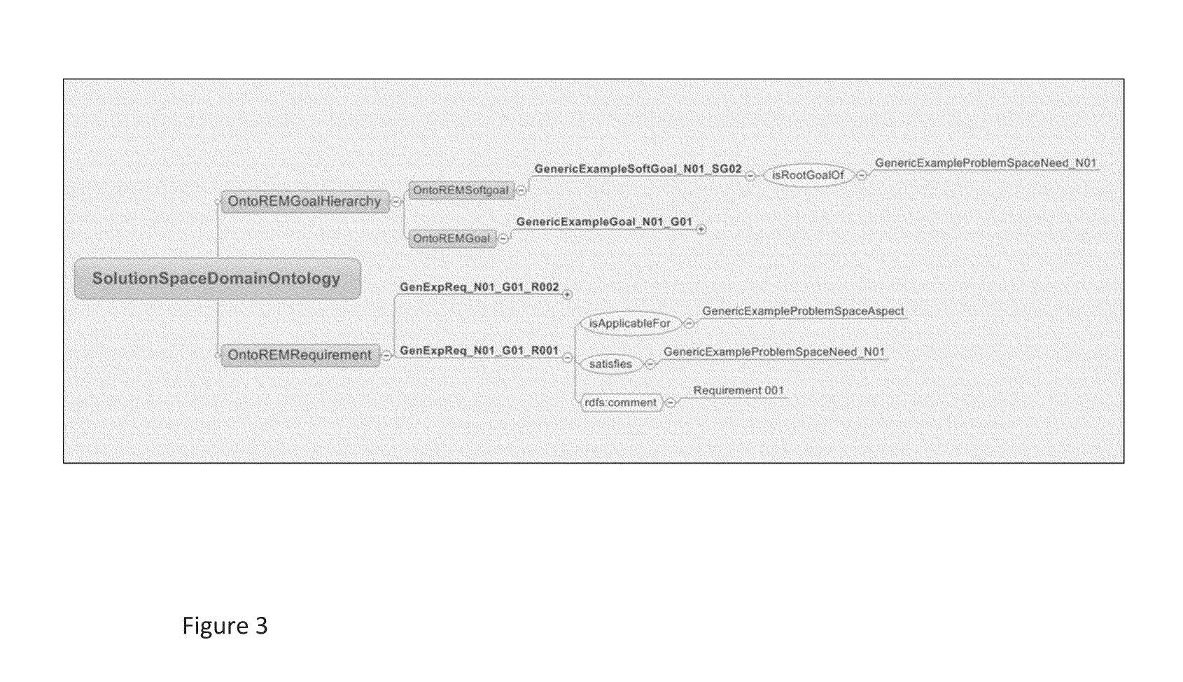

As the metamodel defines the templates used for the mindmap all generated mindmaps conform to the agreed and customizable transformation template. An example of such a template is shown in FIG. 3.

FIG. 3 is an example of a solution space domain ontology mindmap generated at step S106, where the user has selected the classes regarding the solution space.

Once the mindmaps have been generated the process may stop or return to step S104.

If the user selects the option to generate a visual mindmap for the metamodel of the uploaded ontology the process proceeds to step S108.

At step S108 a mindmap is generated from the uploaded ontology which will graphically represent aspects of the ontology metamodel. In an embodiment all aspects of the metamodel as presented including the defined classes, the subclasses of each class, the entire class hierarchies and relationships, the identified object properties and datatype properties, and the ranges and domains of each property.

Advantageously, as with the mindmap for the chosen classes of the uploaded ontology (as per step S106) the mindmaps generated at step S108 also work as a data template. Such a data template is called an Ontology Metamodel Mindmap Template: and can be reused later to import data back into the associated ontology files in order to update their metamodels (classes, subclasses, properties etc.).

The mindmaps are automatically generated at step S108. As the uploaded ontology is defined in the OWL notation the standardized format of the ontology is used to enable the automatic generation of the metamodel mindmap.

Within the ontology all existing classes of the metamodel are identified. Such identification is possible due to the OWL notation which defines the existence of each class. Such identification is independent from any existing instances in the domain ontology. As well as identifying all existing classes their hierarchy and all allowed object type and datatype properties along with their defined domains, ranges, features etc., are identified. Due to the standardized OWL notation such information may be automatically associated with each class.

The number of classes and the hierarchy of the objects in the class is determined and plotted as branches and sub-branches. The visual separation between the individual branches and sub-branches may be adjusted according to user preference. The data type properties (e.g., ranges etc.) is then rendered on, or next to, the appropriate branch or sub-branch thereby resulting in the automatic generation of the mindmap. In an embodiment the mind map is generated using the MindMapper software program.

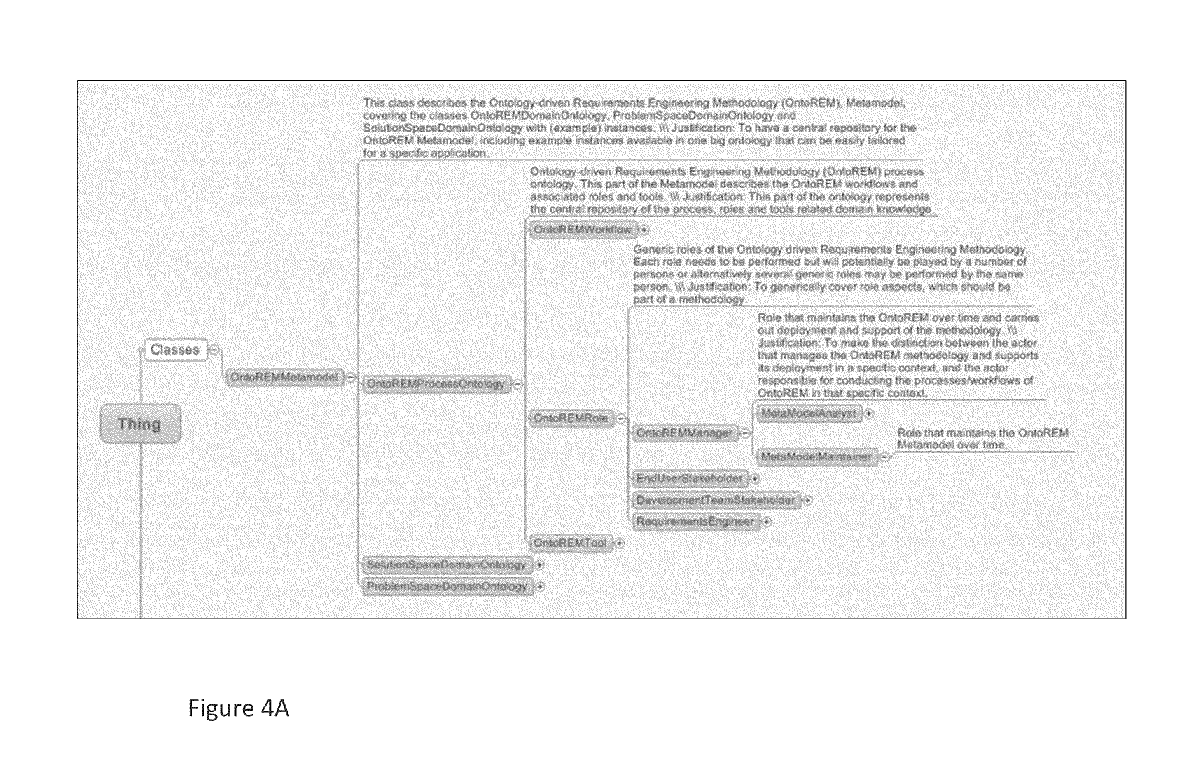

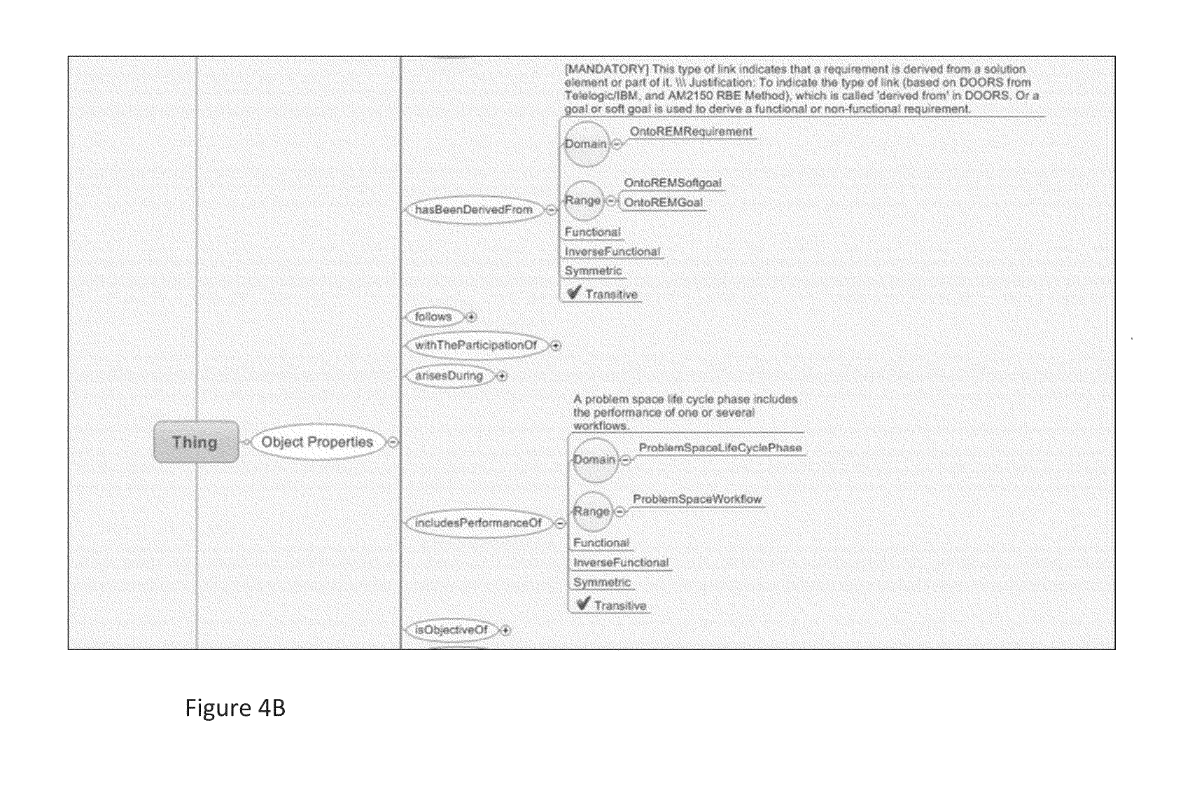

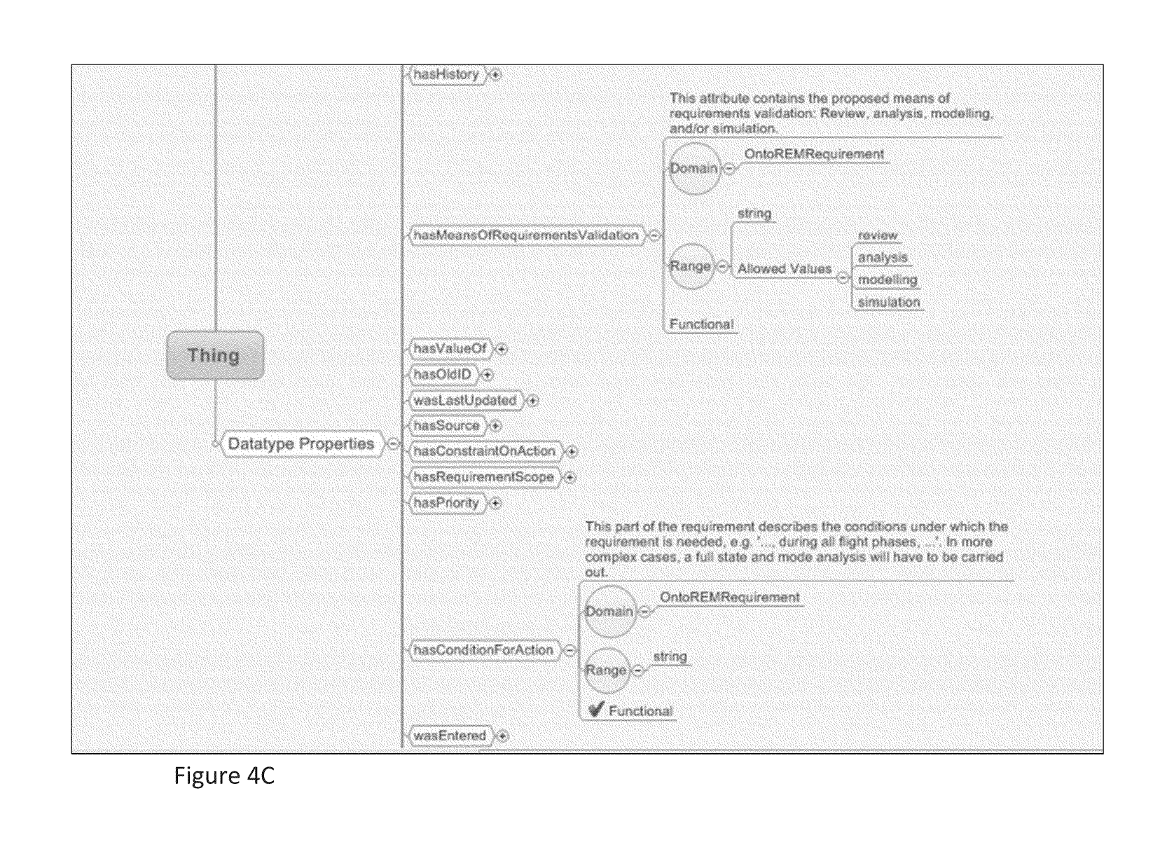

FIG. 4A is an example of the class hierarchy mindmap, FIG. 4B is an example of the mindmap for object properties and FIG. 4C an example of the datatype properties generated at step S108.

Once the mindmaps have been generated the user may save the generated mindmaps and the process may stop or return to step S104.

If the user selects the option to generate traceability mindmaps of the uploaded ontology the process proceeds to step S110.

At step S110 the traceability mindmaps for the needs, goals and requirements defined in the uploaded ontology are produced. The traceability mindmaps graphically represent the relationships between the needs, goals and requirements defined in the uploaded ontology.

The traceability mindmaps therefore visualise the links between the various requirements within the ontology.

When a traceability mindmap is generated from an uploaded domain ontology that conforms with the metamodel (and is described in the OWL notation), all instances of the class need are identified. For each identified need the system exports the name and the description of each instance, as well as the information which are the need's sub-goals, root goals and associated requirements that are linked to the need. Furthermore the system identifies and exports all instances of the classes goal/soft goal and requirement, again name and description of each only, as well as their traceability information. Such information for each need is identifiable, and expressed, in the uploaded ontology using the OWL notation.

As the ontology describes the needs, goals and their hierarchy (root-goals, sub-goals etc.) as well as the requirements linked to the need, for each need the goals and relevant information may be plotted. The resulting traceability mindmap shows at level 1 of the mindmap all identified needs, and for each such need, at subsequent levels in the mindmap, the goal hierarchy with the associated requirements at the lowest level of the mindmap, linked to the relevant root goal/soft goal. To aide end user comprehension all needs, goals and requirements are marked (font, colour, and boundary per need) in accordance with the agreed and customizable transformation template.

In all instances of the automatically generated mindmaps, different graphical representations are used to distinguish between the instances, classes, goals etc. Therefore, the end user is able to determine, from viewing the generated mindmap, whether a part of the mindmap relates to, say an instance or a class.

An example of the different graphical representations used in an embodiment is shown in Table 1.

TABLE 1

| | Mapping Concepts |
|---|---|
| Generated Elements in Mindmaps | in Ontology |
| 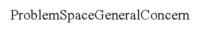 | A rounded-rectangle with turquoise fill colour |
| | indicates a class |
| 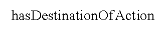 | A hexagon with pale yellow fill colour indicates a |
| | datatype property |
| 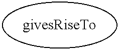 | An oval with pale yellow fill colour indicates an |
| | object property |
| 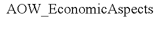 | A bold blue font with no shape indicates an |
| | instance |
| 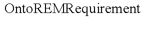 | A normal black font with no shape indicates a |
| | property value |
| 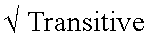 | The red-check icon indicates that whatever follows |
| | it is selected |
| 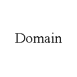 | A yellow circle named Domain indicates domains of properties |
| 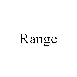 | A yellow circle named Range indicates ranges of properties |

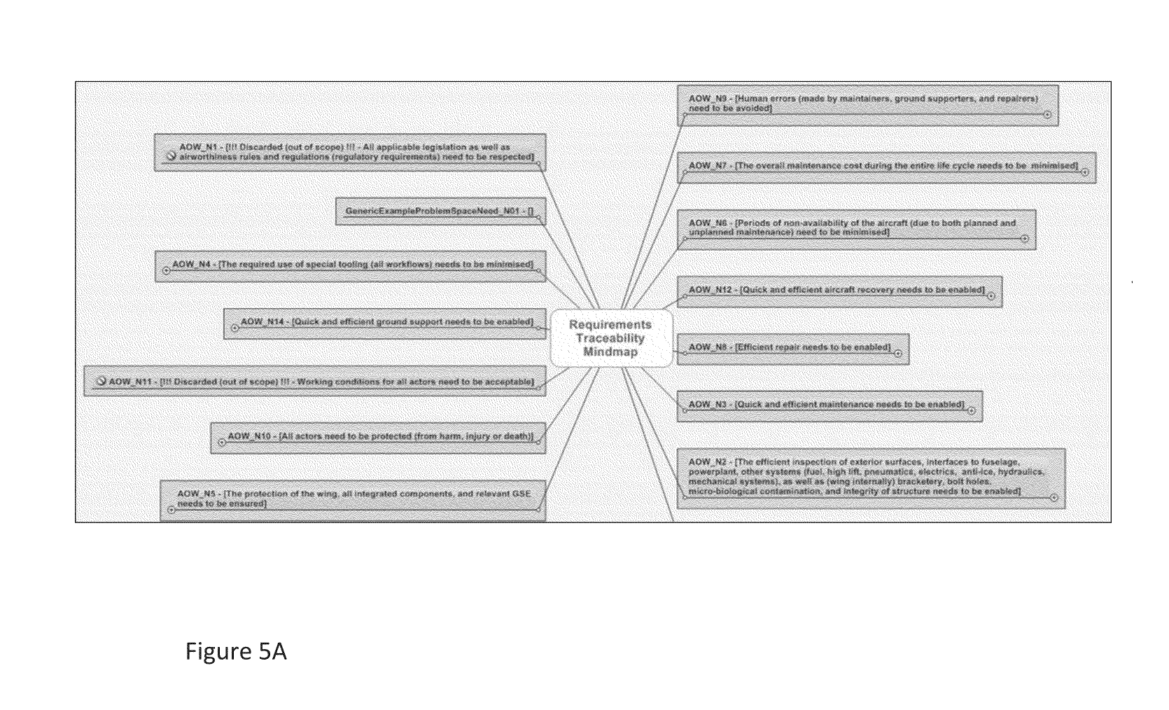

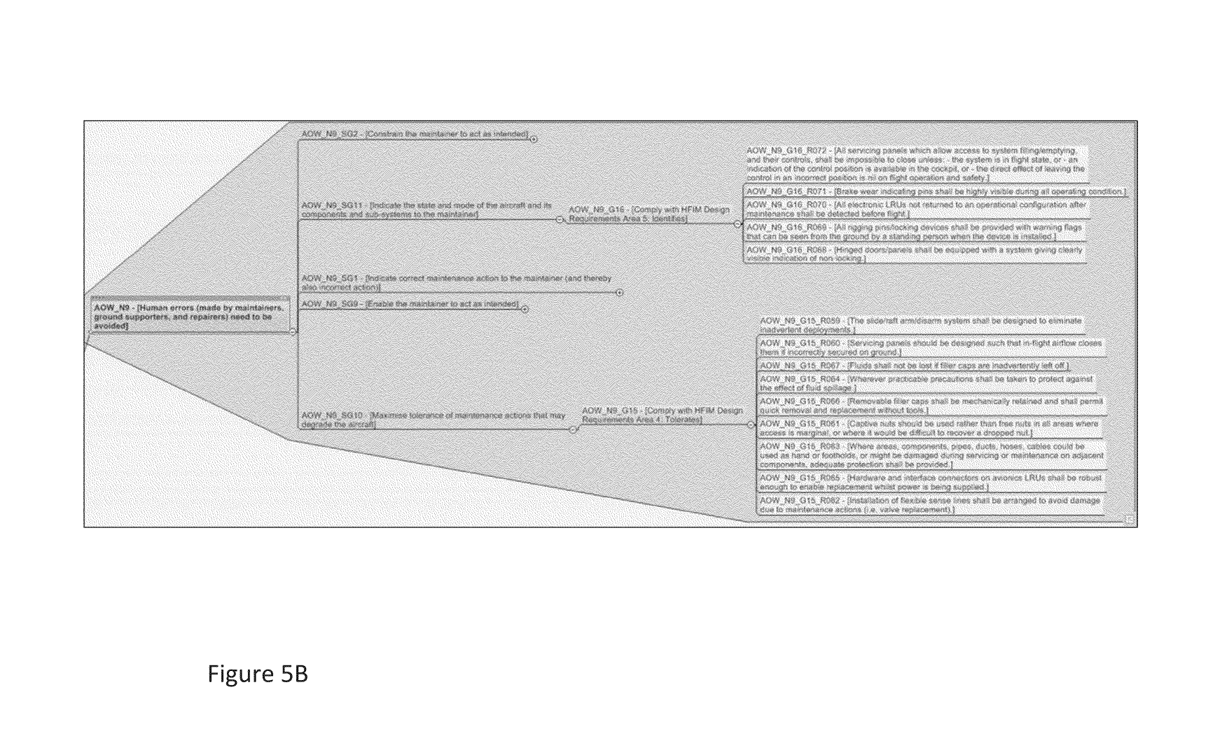

FIG. 5A is an example of a traceability mindmap generated for the needs of a project. In the example shown the project is the design of an aircraft wing. FIG. 5B is an example of the traceability mindmap for the associated goals, root goals and requirements for a particular need as identified in FIG. 5A. In the example shown in FIG. 5B the need is the reduction in human error as shown in FIG. 5A.

FIG. 2B is a flow chart of the process of importing an updated mindmap into a domain ontology.

At step S202 the mindmap is displayed. The mindmap has been automatically created as with reference to FIG. 2A steps S104 and S106. Alternatively, the mindmap may have been created manually (for example in order to populate for the first time a given uploaded domain ontology).

At step S204 the user interacts withy the displayed mindmap. During the elicitation or consultation process the user (for example a requirements engineer) will review the mindmap and populate the mindmap according to the needs of the projects. For example, a new goal may be identified during the consultation process. In order to update the mindmap the user may select a similar goal, and copy and paste the needs, information, hierarchies, etc., form the existing goal into the mindmap and update the information so that it is more relevant to the newly identified goal. Such editing of the mindmap in an embodiment occurs using known functionality in a commercial mindmapping tool such as the MindManager software.

Once the mindmap has been updated the invention provides the ability to update the ontology to reflect the updates made in the mindmap (for example, the addition of the new goal). This represents the bi-directional nature of the invention: i.e. the ability to generate mindmaps from domain ontology, review and make amendments to the mindmaps and update the related domain ontologies. Where an ontology has been uploaded to the invention, a previously created mindmap template (as created in a previous instance of use of the invention, as described with reference to steps S104 and S106) is applied to the ontology.

Furthermore the user is able to edit either the ontology or the mindmap and the changes made during the editing process may be imported back into the corresponding mindmap or ontology as the case may be.

At step S206 the user imports the updated mindmap into the domain ontology. In order to ensure the continued viability of the ontology the updates to the mindmap must be translated back into the ontology in the OWL DL.

As the traceability mindmap represent a graphical visualization of all instances of the classes need, goal/soft goal and requirement and how they are linked, this information is read out from different parts of the domain ontology, i.e. the problem space ontology and the solution space ontology of the domain ontology.

This means that only limited aspects of the information available in the domain ontology is visualized in the traceability mindmap. For example for a given need, any related properties other than the ones needed to display the traceability of the goal hierarchy and towards the requirements will not be visualized. Therefore, it is not possible to import it again into the uploaded domain ontology after it has been updated in the mindmapping environment (rather like a snapshot taken of the domain ontology at a given point in time).

Therefore at step S206 it is only possible to update the mindmaps of selected classes or the mindmap of the metamodel.

If at step S206 the user imports a mindmap of selected classes the process continues to step S208. If at step S206 the user imports a mindmap of the metamodel, the process continues to step S210.

At step S208 the user has edited the mindmap of selected classes that are either updated mindmaps that had been previously generated by the invention (as per FIG. 2A), or mindmaps that have been created manually in order to populate for the first time a given uploaded domain ontology. Then the information contained in the updated mindmap is imported into the corresponding, uploaded ontology. As the mindmap is generated to conform to the metamodel template the importing of the mindmap into the ontology also conforms to the template.

Where object properties have been updated for specific instances in the mindmap, there are principally two different ways to update the underlying domain ontology: Either the new values of the corresponding object properties are updated in the sub-branches of all concerned instances in the mindmap, or the updates of the object property values can be ignored before the import and then manually selected in the domain ontology, using an ontology editor.

The invention allows for the automatic updating of the ontology based on the amendments made. As the domain ontology is specified in the OWL notation the information regarding the data properties (values, ranges etc.) as well as their hierarchy within the mindmap, is recorded conforming to the OWL notation and the template.

At step S210 the amended mindmaps of the metamodel are imported back into the ontology. The mindmaps of the metamodel are generated as described above with reference to step S108.

The process of updating the ontology based on the changes made to the mindmap is as described above with reference to step S208. The mindmaps of the metamodels are either updated metamodel mindmaps that had been previously generated by the invention, or metamodel mindmaps that have been created manually in order to create for the first time a new (but still empty, i.e. without instances) metamodel ontology. Then the information contained in the uploaded mindmap is imported into the corresponding, uploaded ontology file. As with the mindmap of the selected classes the updated metamodel mindmap conforms to the agreed and customizable transformation template, in order to enable a successful import into the uploaded domain ontology.

Whilst the embodiments described above are given with reference to requirements engineering processes (in which requirements engineering software, such, as OntoREM, is used to generate the ontology) the present invention provides the ability to generate and visualize a mindmap from any ontology file, which conforms to the OWL notation. For example, if a user were to generate an ontology regarding food and drink then the methodology as described with reference to FIGS. 2A and 2B enable the user to display and edit the food and drink mindmap.

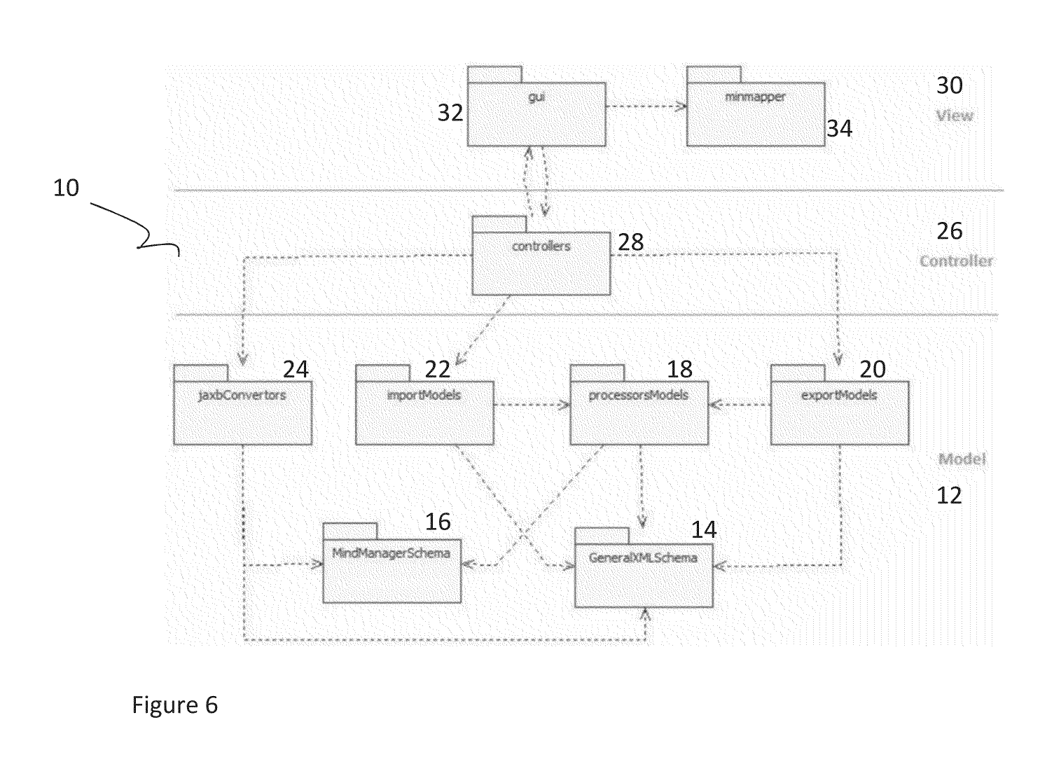

In FIG. 6 there is shown a schematic representation of the architecture of the ontology driven mind mapping (OMM) software. In an embodiment the software relates to an ontology driven requirements engineering process.

Due to the iterative nature of the invention, with the bidirectional functionality a model-view-controller (MVC) architecture is used. The architecture 10 comprises a model layer 12, a controller layer 26 and view layer 30. The architecture 10 therefore describes the visualization module 112 (as described with reference to FIG. 1) as well as the interface between the visualization module 112 and the requirements engineering module 110.

The model layer 12 comprises the following modules: a General XML schema 14; MindManager schema 16; processor module 18; export model 20; import model 22; and Jaxb Convertors 24.

The controller layer 26 comprises a controllers module 28.

The view layer 30 comprises a GUI module 32 and mindmapper module 34.

As shown in FIG. 6 each layer interacts with its adjacent layer, and components within each layer interact with each other.

The model layer 12 encapsulates the data from the problem domain in which the real-world projects are defined. The model layer therefore contains the data regarding the problem domain and the solution domain tor the ontological requirements engineering system. The population of the problem domain, the solution domain and the use of metamodels to enable the ontological population of the solution domain is as described in U.S. Ser. No. 13/364,603.

The model layer also allows a user (such as but not limited to a requirements engineer, Systems Engineer, Software Engineer, Requirements Engineer or Requirements Manager) to change the state of the ontology in the problem or solution domain as well as the metamodel. Additionally the model layer controls the loading of previously saved ontologies and the generation of the mindmaps.

The model layer is therefore responsible for:
Uploading OWL ontology files to the system and creating trees of Java objects (i.e. Java representations) that represent all the elements of the uploaded ontology as Java objects in the memory.
Parsing the OWL files uploaded and retrieving, changing, or processing the state of the ontology uploaded using Protégé APIs.
Un-marshalling the mindmap files selected by the user and creating trees of Java objects that represent the elements of the selected mindmaps as Java objects in memory.
Validating the mindmaps uploaded against the general XML Schema; mapping/converting the selected mindmaps to the general XML Schema, if necessary.
Generating visual mindmaps for the uploaded ontology that represent the ontology metamodel, classes, subclasses, properties, etc.
Importing validated mindmaps into the corresponding parts of the ontology uploaded.

Within the model layer 12 there are interacting several components which serve to provide the above listed functionality.

The General XML Schema 14 is a software component which stores the uploaded mindmaps regardless of their format. The general XML schema 14 interacts with the import modules 22, export modules 20, processor modules 18 and Java converters 24.

Mindmaps which are uploaded are converted into a general XML schema. This ensures that the invention is not restricted to a specific mindmap format and enables the general schema to be upgraded and changed easily and ensures that the changes are reflected across all mindmaps without the need for editing each map individual.

The general XML schema therefore defines how the mindmap document is to be structured. By adopting the general XML schema the information may be more easily shared across projects and/or domains. Furthermore all the elements, entities and attributes defined in the adopted XML schema 14 are automatically mapped into system building blocks using Java Architecture for XML Binding (JABX) convertor 24. Preferably the general XML schema utilizes the same classes defined in the commercially available MindManager program, as defined by the MindManager XML schema.

The MindManager schema component 16 is responsible for MindManager mindmaps. Whilst it preferably has the same classes as the general XML schema; it only deals with MindManager format to allow converting the MindManager mindmaps selected by the user into mindmaps that conform to the general schema used in the system. In further embodiments one or more further classes are used to deal with other mind mapping software formats.

The duplication of the classes is used to make the general XML schema 14 separate, and decoupled from any software product. Therefore as the general schema does not depend on any specific program (though in the preferred embodiment it is based on MindManager) it is not affected by changes or upgrades to other software programs.

The export module 20 is responsible for automatic generation of the ontology mindmap templates, metamodel mindmap templates, and traceability mindmaps from the uploaded data. The export module interacts with the controller layer 26 and the processor module 18 and general XML schema module 14 on the model layer 12.

The module comprises three classes:
MindMapTemplateModel class is responsible for performing the algorithms required to automatically generate ontology mindmap templates for any selected class of the uploaded OntoREM ontology instance. Such mindmap templates graphically represent the class's individuals, their datatype and object properties, and the values assigned to the properties.
MetamodelMindMapTemplateModel class is responsible for performing the process of generating metamodel mindmap templates for the metamodel of the OntoREM instance uploaded. Such mindmap templates visualise the OntoREM ontology metamodel, displaying the classes' hierarchy of the ontology, and the object and datatype properties defined in the ontology along with their domains, ranges, features, etc.
TraceabilityMindMapModel class is responsible for generating traceability mindmaps of all the needs, goals, soft-goals and requirements specified in the OntoREM instance uploaded. Such mindmaps display the defined needs, goals, soft-goals and their associated requirements in one graphical mindmap and visually show the relationships and traceability between them.

The functionality of the three classes is as described above with reference to FIG. 2A.

The import models component 22 is responsible for automatically importing domain knowledge into and updating the metamodels of the OntoREM ontology instance. The import model 22 interacts with the controller layer 26 and the processor module 18 and general XML schema module 14 on the model layer 12. The classes of the import model 22 are described below:
ImportMindMapTemplateModel class is responsible for importing the domain knowledge specified in the ontology mindmap templates into the OntoREM instance uploaded to the system and updating the relevant parts of the OntoREM metamodels accordingly. This class deals with the three classes of OntoREM: OntoREMProcess, ProblemSpaceDomainOntology and SolutionSpaceDomainOntology.
MetamodelImportModel class is responsible for importing the changes specified in OntoREM metamodel mindmap templates into the uploaded OntoREM instance and updating its metamodel accordingly.

The functionality of the classes is as described with reference to FIG. 2B.

The processors models component 18; this interacts with the import models 22 and export models 20 as well as the general XML schema 14. It does not interact with the controller layer 26. The processors models component 18 provides shared services that are needed by the export model 20 and import model 22 components to process the ontologies and mindmaps uploaded to the system and hence successfully carry out their tasks. Since such services are required by both the import models and export models components, it is reasonable that they are implemented in a separate component that acts as an underlying base for the other two components in order to enhance the reusability and maintainability of the software.
OWLOntologyProcessor: this class is responsible for converting the OntoREM ontology uploaded to the system into a Java representation in the memory using Protégé-APIs and creating a static shared object of such representation to be used by all the software components.
MindMapProcessor: this class is responsible tor converting the mindmap templates selected by the user into java representations in the memory using the general schema (JAXB) and creating static shared objects of such representations to be used by all the software components.
TopicProcessor: this class is responsible for customizing topic objects of the mindmap templates and specifying their branches, subtopics, parent nodes, boundaries, titles, etc. Therefore the end user can further define the mindmaps according to user preference.
MindManagerProcessor: this class is responsible for converting MindManager mindmaps selected by the user into java representations in the memory using the MindManager schema, and creating static shared objects of such representations to be used by all the software components.
PasswordProcessor: this class is responsible for checking and updating the access rights of the system users.
TraceabilityMapSettings: this class holds the default settings defined by the system to generate traceability mindmaps.
TemplateSettings: this class holds the default setting defined by the system to generate ontology and metamodel mindmap templates.

JAXBConvertors Component; this component is responsible for processing the conversions between the formats of the mindmaps selected by the user and the general format specified in the general schema. This component has one convertor currently, MindManagerConvertor, but it can be easily extended by adding other converters.

The classes are:
JAXBSchema class is responsible for un-marshalling the mindmaps that have been converted to the general schema.
MindManagerJAXBSchema class is responsible for un-marshalling MindManager mindmaps before converting them to the general XML Schema.
MindManagerConvertor class is responsible for performing the conversion process between the MindManager format and the general format adopted in the system (in this particular case, it is a straightforward conversion).

As the ontology is generated using the OWL notation the conversion of the ontology to a Java representation is possible due to the predictable format of the ontology end mindmaps.

The controller layer 26 comprises a single component, the controllers 28. The controller layer 26 calls the model methods (see above) and controls the data processing. Furthermore, the controller also modifies the view representations to display the results back to the user. This layer is responsible for:
Rendering the user interactions from the view and determining the needed system behaviors.
Calling the appropriate methods in the model according to the user inputs and interactions to generate the required outputs.
Updating the view according to the changes to the model date in order to display the results to the user.

The controllers component 28 is therefore responsible for the communication with the view layer, translating the user interactions into commands, and passing the commands to the appropriate objects of the model layer in order to deliver the outputs required by the user.

The MindManagerController class is responsible for rendering the user interactions received from the view components (see below) and executing the appropriate class in response. It is also responsible for passing the results back to the appropriate views to update their representations. The inner classes act as action listeners and control the process logic based on the users inputs (i.e. calling the appropriate convertors, passing the converted mindmaps to the appropriate components, sending the required commands to the right components, passing the results back to the associated views, etc.). The inner classes are:
GenerateMindMapTemplateListener: it controls the flow of the generation process of ontology mindmap templates.
GenerateMetamodelMindMapListener: it controls the flow of the generation process of metamodel mindmap templates.
GenerateTraceabilityMapListener: it controls the flow of the generation process of traceability mindmaps.
ImportMindMapTemplateListener: it controls the flow of the importing process of ontology mindmap templates.
ImportMetamodelTemplatelListener: it controls the flow of the importing process of metamodel mindmap templates.

Therefore such inner classes control the processes as described with reference to FIGS. 2A and 2B.

To this extent the controllers 28 receive inputs to and from the jaxbconvertors 24, import module 22 and export module 20 in the model layer 12. The controllers 38 also communicate with the GUI module 32 in the view layer 30.

The GUI module 32 comprises three classses:
LoginForm: this class initializes and displays a GUI form which asks the user to enter a password before accessing to some system functionalities.
ChangePassworForm: this class initializes and launches a GUI form which asks the user to enter the current and new passwords in order to change the access rights.
MindMapperGUI: this class contains all the GUI components responsible for displaying the main view of the OntoREM-MindMapper (i.e. the MindMapper View). It initiates and contains all the frames, panels, menus, labels, buttons, etc. shown to the users.

The use of the login and password are optional. The MindMapperGUI controls the generation of the mindmaps.

The mindmapper Component 34 provides the commands to visualise the mindmaps and comprises:
LableHyperLink: this class is responsible for designing and displaying hyper links which take the user to the generated mindmaps.
FileChecker: this class is responsible for checking the extension of the files selected by the user: it produces error messages if the user has selected a wrong file.
MindMapper: this is the main class that launches the OntoREM-MindMapper application; it has the main method.
ColourChooser: this class is responsible for initializing and displaying a dialog box from which the user can pick a particular colour to be used in the system settings.
FileChooser: this class is responsible for initializing and displaying a dialog box from which the user can pick a particular file to be used in the system.
SaveFile: this class is responsible for initializing and displaying a dialog box from which the user can select where to save a particular file.

The described architecture allows for the bi-directional flow of data between the model layer 12 and view layer 30 where the inputs and outputs may be affected.

Therefore, the present invention allows for the automatic generation of mindmaps from an uploaded ontology. The invention also allows the user to view and edit various mindmaps and import the edits to the ontology used to create the initial mindmap. Such bi-directional functionality provides a more efficient user interface in which errors during the mindmap creation and updating of the ontology are avoided.

1. A computer implemented method comprising the steps of, at a computer processor:
receiving an ontology based specification file;
receiving an input from a user indicative of one or more aspects of the ontology based specification file to visualise;
automatically generating, at a processor, a mindmap derived from the selected aspects of the ontology based specification file; and
displaying said derived mindmap at a display.

2. The method of claim 1 wherein the ontology based specification file is written in the Web Ontology Language - OWL-.

3. The method of claim 2 wherein the ontology based specification file defines a problem space, a solution space and a metamodel in the Web Ontology Language.

4. The method of claim 1 wherein the ontology based specification file is a requirements engineering based specification file.

5. The method of claim 1 wherein the user selects one or more classes of the ontology to visualise in the mindmap.

6. The method of claim 5 wherein the mindmap generated is representative of the selected classes, and one or more of its subclasses, class hierarchies, instances in each class, properties of each instance and values assigned to the properties.

7. The method of claim 1 wherein the user selects to visualise, as a mindmap, a metamodel associated with the uploaded ontology specification file.

8. The method of claim 7 wherein each class is selected from the received ontology specification file to generate the visualization of the metamodel mindmap.

9. The method of claim 7 wherein the hierarchy of classes and the associated properties are selected from the received ontology specification file to generate the visualization of the metamodel mindmap.

10. The method of claim 1 wherein the user selects to visualise the traceability of the needs, goals and requirements defined in the ontology.

11. The method of claim 10 wherein the goals, sub-goals and root-goals, their hierarchy and links of the traceability are visualized.

12. The method of claim 11 further comprising the instances of the needs, goals and requirements, name and description being visualized in the traceability mindmap.

13. The method of claim 1 wherein the different aspects of the mindmaps, classes, goals, sub-goals, data properties, instances, values and domains have different graphical representations.

14. The method of claim 13 wherein the graphical representations of the different aspects are user editable.

15. A computer implemented method comprising the steps of, at a computer processor:
displaying a mindmap based on one or more selected aspects of an ontology specification file written in the Web Ontology Language;
editing one or more features of the displayed mindmap;
automatically updating the ontology specification file so as to reflect the changes made to the mindmap in the ontology specification file.

16. The method of claim 15, further comprising:
receiving an ontology based specification file;
receiving an input from a user indicative of one or more aspects of the ontology based specification file to visualise; and
automatically generating the mindmap from the selected aspects of the ontology based specification file.

17. The method of claim 15 wherein the ontology specification file is a requirements engineering based specification file.

18. The method of claim 15 wherein the mindmap displayed, and subsequently edited, is a mindmap of one or more classes selected from the ontology specification file.

19. The method of claim 15 wherein the mindmap displayed, and subsequently edited, is a mindmap of a metamodel defined in the ontology specification file.

20. A computer system comprising:
a memory having one or more ontology based specification files;
a user input device configured to enable a user to provide an input indicative of one or more aspects of the ontology specification file to visualise;
a processor configured to automatically generating, a mindmap derived from the selected aspects of the ontology specification file;
a display for displaying said derived mindmap at a display; wherein
the user input device is further configured to enable the user to edit one or more aspects of the displayed mindmap and the processor is further configured to automatically update the ontology based specification file to reflect the changes made to the displayed mindmap.
